(19) United States
(12) Patent Application Publication
(10) Pub. No.: US 2008/0087848 A1
(43) Pub. Date: Apr. 17, 2008

(54) ANTI-RADIATION STRUCTURE

(75) Inventors: Yen Hsiu Lin, Taipei County (TW); Tsung-tsan Su, Hsinchu City (TW); Ming-Jyh Chang, Keelung City (TW); You-Chia Chang, Taichung City (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/753,520

(22) Filed: May 24, 2007

(30) Foreign Application Priority Data
Oct. 14, 2006 (TW) TW95137897

(51) Int. Cl. G02B 5/00

(52) U.S. Cl. 250/505.1

(57) ABSTRACT

The invention provides an anti-radiation structure comprising a substrate, a reflective layer adjacent to the substrate, and a periodic grating adjacent to the reflective layer. The invention also provides another anti-radiation structure comprising a substrate and a periodic grating adjacent to the substrate. The described structures may reflect or diffract incident radiation at a specific wavelength.

### BACKGROUND OF THE INVENTION

1. Field of the Invention

The invention relates to an anti-radiation structure, and in particular relates to a periodic grating structure on the substrate surface, thereby reflecting or diffracting an incident radiation at a specific wavelength.

2. Description of the Related Art

Cataracts are not rare in oldster ocular disease. In eyeball structure, the lens is a little convex and located behind the pupil of the eye, thereby focusing incident light and forming an image on the retina. Because veins distributed on the eyeball are few, thermolysis of the eyeball is deficient. If exposed to ultraviolet light, the lens, under heat may undergo pathological change, e.g. a turbid lens referred to as cataract.

In addition, colorblindness is a common eye disease. Eyes can distinguish different colors by specific pigments of photosensitive retina cells. Each photosensitive cell has one specific pigment (red, green, and blue), such as photosensitive particles on camera film.

Colorblindness cannot correctly discriminate colors, or confuse specific colors. Men have a higher probability than women to be colorblind. 8% of men are colorblind, and only 0.5% of women are colorblind. Most colorblind are color weak, and the people with full colorblindness are only 1/100,000.

Daltonism is congenital colorblindness and cannot be cured. Sufferers of daltonism are almost all men. Most daltonism sufferers are red-green colorblind, and are unable to distinguish purple-blue.

Another kind of colorblindness is acquired due to pathological changes in retina or optical nerves, such as trauma or glaucoma. Most acquired colorblindness cannot distinguish yellow-blue, but can easily distinguish blue-purple. Daltonism (red-green colorblindness) is difficult to cure by conventional medicine, however, most colorblindness is color weak. Color weak is weak in determining colors and not full colorblind.

Current treatment of cataracts involves transplanting an artificial lens, but the effect of this surgical operation is different for different patients. Additionally, color weakness is one of sapiens eye diseases. Therefore, an anti-radiation structure reflecting or diffracting an incident radiation at a specific wavelength range is called for improving and preventing the described eye diseases.

### BRIEF SUMMARY OF THE INVENTION

Accordingly, the invention provides an anti-radiation structure which reflects or diffracts an incident radiation at a specific wavelength, thereby reducing the danger of exposure to the radiation, and modifying the color distinguishing ability of color weak people.

The invention provides an anti-radiation structure, comprising a substrate; a reflective layer adjacent to the substrate; and a periodic grating adjacent to the reflective layer for reflecting an incident radiation.

The invention further provides an anti-radiation structure, comprising a substrate and a periodic grating adjacent to the substrate for diffracting an incident radiation.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1-4 are cross sections of anti-radiation structures of the invention;

FIGS. 5-11 are a schematic view showing simulated reflection results versus different wavelength of incident light according to the invention; and

FIG. 12 is a schematic view showing simulated transmission results versus different wavelength of incident light according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides simulated experiments to show the anti-radiation effect, such as UV light, blue light, and red light. The invention can be applied in lens, window, or other anti-radiation structures. For simplifying the factors of the simulated experiments, material dispersion is neglected, and the incident light is hypothesized to be perfect coherence and normal incidence.

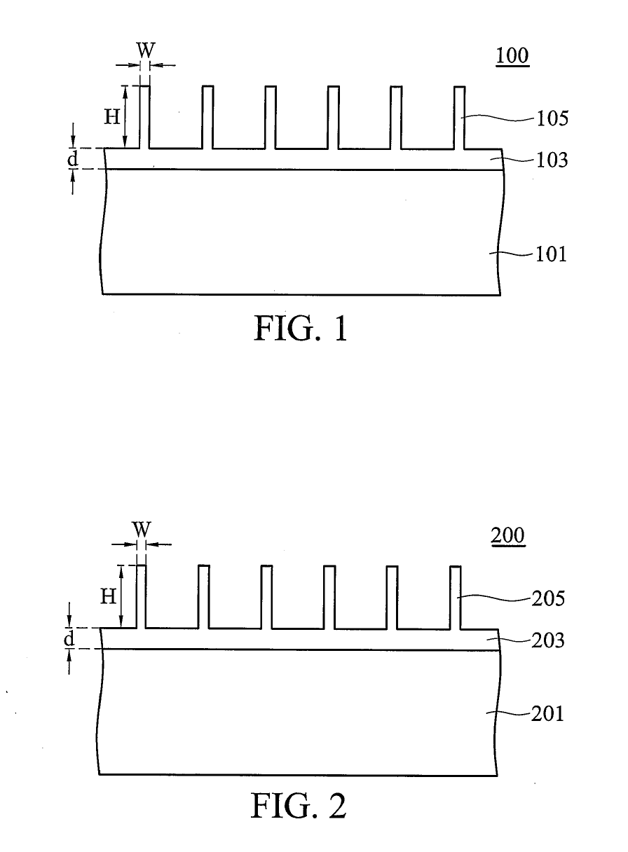

FIG. 1 is a cross section of an anti-radiation structure 100 including a substrate 101, a reflective layer 103, and a periodic grating 105. The substrate 101 may be glass, plastic, or organic-inorganic composite, with glass used in the simulated embodiments of the invention. The reflective layer 103 and the periodic grating 105 have a refractive index of 1.4 to 2.0. In preferred embodiments, the reflective layer 103 and the periodic grating 105 have substantially greater refractive indices than the substrate 101. Furthermore, the reflective layer 103 and the periodic grating 105 can be same or different materials, and the reflective layer 103 and the periodic grating 105 may be in-mold if the same material.

For preventing cataracts, the invention provides an anti-radiation structure 100 to reflect the incident UV light of 200 nm to 400 nm, with indices of the reflective layer 103 and the periodic grating 105 substantially exceeding that of the substrate 101, and more preferably about 1.6 to 2.0. The duty cycle of periodic grating 105, ratio of grating width to grating period, is preferably 0.15 to 0.8, and more preferably about 0.2 to 0.3. The grating period is preferably about 10 nm to 500 nm, and more preferably about 100 nm to 200 nm. The grating height H is about 50 nm to 210 nm. The thickness d of the reflective layer 103 is about 5 nm to 70 nm.

For modifying red color vision deficiency, the invention provides another anti-radiation structure 200 as shown in FIG. 2. The anti-radiation structure 200 reflects the incident short wavelength light of 400 nm to 550 nm, such that red color perception is accurate. The indices of the reflective layer 203 and the periodic grating 205 substantially exceed that of the substrate 201, and more preferably are about 1.6 to 2.0. The duty cycle of the periodic grating 205 is preferably 0.15 to 0.8, and more preferably about 0.2 to 0.3. The grating period is preferably about 10 nm to 500 nm, and more preferably about 100 nm to 200 nm. The grating height H is about 50 nm to 210 nm. The thickness d of the reflective layer 203 is about 10 nm to 120 nm.

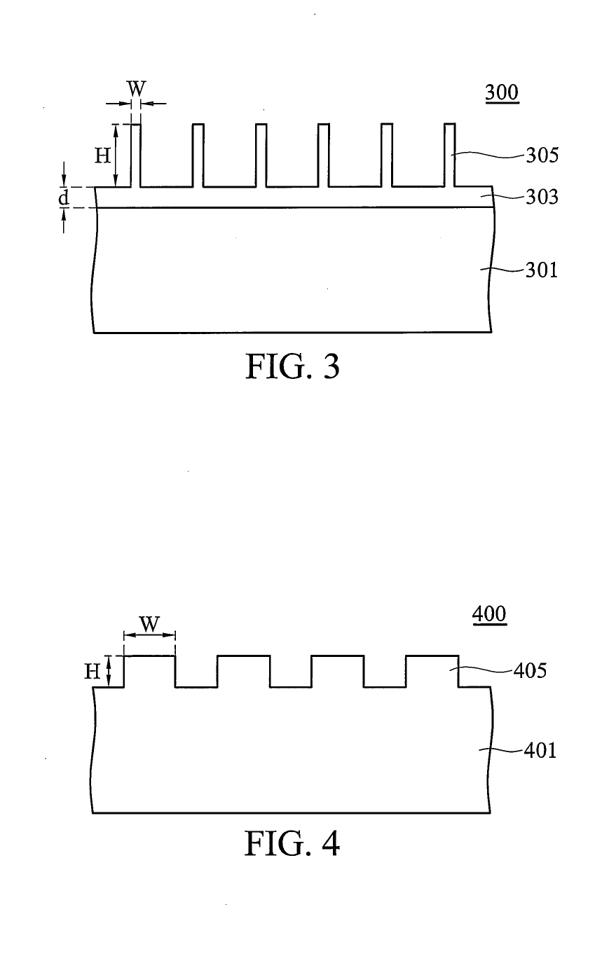

For modifying the blue color vision deficiency, the invention provides another anti-radiation structure 300 as shown in FIG. 3. The anti-radiation structure 300 reflects the incident long wavelength light of 550 nm to 700 nm, such that blue color perception is accurate. The indices of the reflective layer 303 and the periodic grating 305 substantially exceed that of the substrate 301, and more preferably about 1.6 to 2.0. The duty cycle of the periodic grating 305 is preferably 0.15 to 0.8, and more preferably are about 0.25 to 0.4. The grating period is preferably about 10 nm to 500 nm, and more preferably about 100 nm to 200 nm. The grating height H is about 5 nm to 130 nm. The thickness d of the reflective layer 203 is about 50 nm to 180 nm.

In addition to the disclosed three-layer structure, the invention also provides an anti-radiation structure 400 without reflective layer, as shown in FIG. 4. The anti-radiation structure 400 includes a substrate 401 and a periodic grating 405. The substrate 401 may be glass, plastic, or organic-inorganic composite, with glass used in the simulated embodiments of the invention. The periodic grating 405 may be glass, plastic, or organic-inorganic composite. In preferred embodiments, the substrate 401 and the periodic grating 405 have substantially similar refractive index, and the substrate 401 and the periodic grating 405 can be same or different materials. The periodic grating 405 and the substrate 401 may be in-mold if the same material. For reflecting the incident UV light of 200 nm to 400 nm, the duty cycle the periodic grating 405 is preferably 0.1 to 0.9. The grating period is preferably about 180 nm to 340 nm. The grating height H is about 10 nm to 400 nm.

Simulated Experiment I

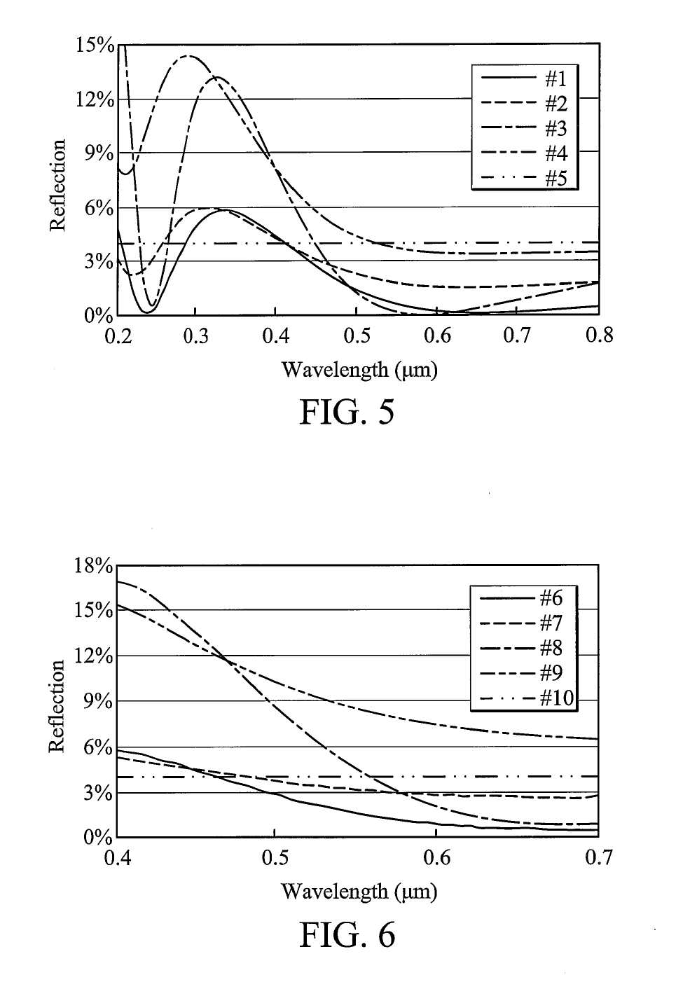

Table I shows the simulated variables of UV reflection of the anti-radiation structure 100. The refractive index of the substrate 101 is 1.5. Variables of Simulated experiment I include grating height H, thickness d of the reflective layer 103, refractive index of the periodic grating 105 and the reflective layer 103 (the periodic grating 103 and the reflective layer 105 are hypothesized to be same material), duty cycle, and grating period T. #5 means no reflective layer and periodic grating are on the substrate 101, i.e. only substrate 101 processes simulation of reflection. Simulated experiment I utilizes transverse electric (TE) light and transverse magnetic (TM) light as incident light. FIG. 5 shows simulated results of reflection versus wavelength, wherein curves 1-5 correspond to #1-5 in Table I. Compared to substrate (#5), the anti-radiation structures of the invention (#1-4) have higher reflection to 200-400 nm UV light, as shown in FIG. 5. Specifically, if the reflective layer 103 and the periodic grating 105 have higher refractive index (1.9) such as #3 and #4, the anti-radiation structure has higher reflection of about 8% to 14%.

TABLE I

| | #1 (TE) | #2 (TM) | #3 (TE) | #4 (TM) | #5 |
|---|---|---|---|---|---|
| Grating height H | 146 nm | 146 nm | 135 nm | 135 nm | 0 |
| Thickness d of the | 31 nm | 31 nm | 26 nm | 26 nm | 0 |
| Reflective layer | | | | | |
| Refractive index | 1.6 | 1.6 | 1.9 | 1.9 | 1.5 |
| Duty cycle | 0.28 | 0.28 | 0.28 | 0.28 | |
| Grating period | 130 nm | 130 nm | 130 nm | 130 nm | |

Simulated Experiment II

Table II shows the simulated variables of short-length visible light reflection of the anti-radiation structure 200. The refractive index of the substrate 201 is 1.5. Variables include grating height H, thickness d of the reflective layer 203, refractive index of the periodic grating 205 and the reflective layer 203 (the periodic grating 203 and the reflective layer 205 are hypothesized to be same material), duty cycle, and grating period T. #10 means that no reflective layer and periodic grating are on the substrate 201, i.e. only substrate 201 processes simulated reflection. Simulated experiment II utilizes transverse electric (TE) light and transverse magnetic (TM) light as incident light. FIG. 6 shows simulated results of reflection versus wavelength, wherein curves 6-10 correspond to #6-10 in Table II. Compared to substrate (#10), the anti-radiation structures of the invention (#6-9) have higher reflection to 400-550 nm visible light, as shown in FIG. 6. Specifically, if the reflective layer 203 and the periodic grating 205 have higher refractive index (1.9) such as #8 and #9, the anti-radiation structure has higher reflection of about 6% to 17%.

TABLE II

| | #6 (TE) | #7 (TM) | #8 (TE) | #9 (TM) | #10 |
|---|---|---|---|---|---|
| Grating height H | 145 nm | 145 nm | 146 nm | 146 nm | 0 |
| Thickness d of the | 81 nm | 81 nm | 51 nm | 51 nm | 0 |
| Reflective layer | | | | | |
| Refractive index | 1.6 | 1.6 | 1.9 | 1.9 | 1.5 |
| Duty cycle | 0.28 | 0.28 | 0.28 | 0.28 | |
| Grating period | 130 nm | 130 nm | 130 nm | 130 nm | |

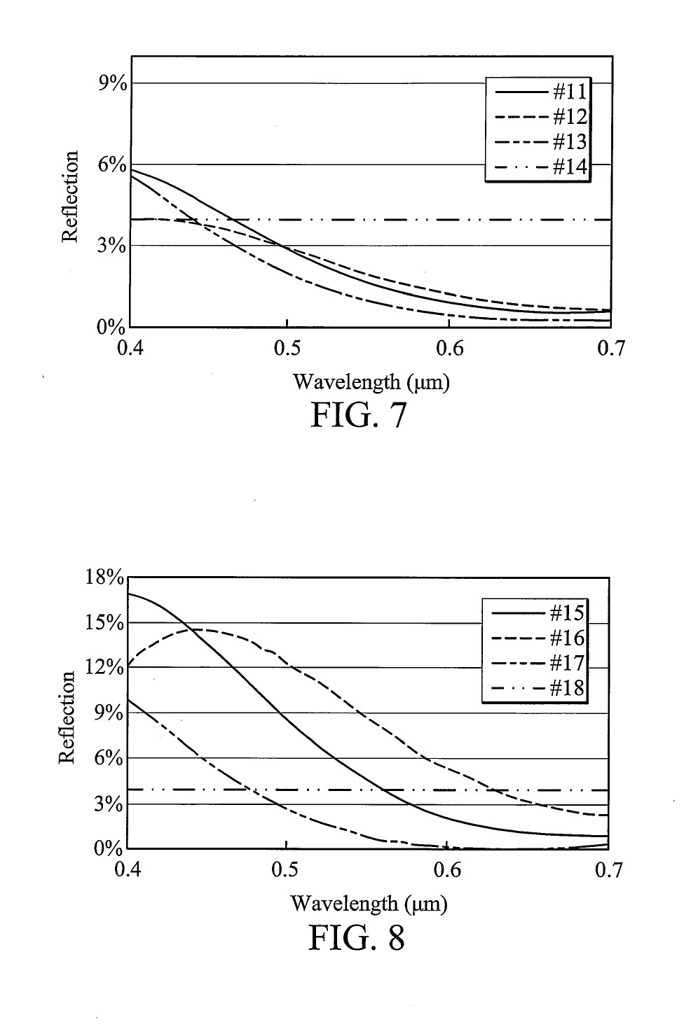

Table III shows the simulated variables of short-length visible light reflection of the anti-radiation structure 200 with different thicknesses d of the reflective layer 203. The refractive index of the periodic grating 205 and the reflective layer 203 is 1.6, the grating height H is 145 nm, and grating period is 130 nm. FIG. 7 shows simulated results of reflection versus wavelength, wherein curves 11-14 correspond to #11-14 in Table III. FIG. 7 shows that curves 11 and 13 have higher reflection, of about 3% to 6%, to short-length visible blue light. When the thickness d of the reflective layer 203 is thicker than 100 nm, the anti-radiation structure 200 (curve 12) has lower reflection, to the short-length visible blue light, than substrate 201 (curve 14).

TABLE III

| | Thickness | | | | |
|---|---|---|---|---|---|
| | d of the | Grating | Refractive | | Grating |
| | Reflective layer | height H | index | Duty cycle | period |
| #11 (TE) | 81 nm | 145 nm | 1.6 | 0.28 | 130 nm |
| #12 (TE) | 112 nm | 145 nm | 1.6 | 0.28 | 130 nm |
| #13 (TE) | 50 nm | 145 nm | 1.6 | 0.28 | 130 nm |
| #14 | 0 | 0 | 1.5 | | |

Table IV shows the simulated variables of short-length visible light reflection of the anti-radiation structure 200 with different thicknesses d of the reflective layer 203. The refractive index of the periodic grating 205 and the reflective layer 203 is 1.9, the grating height H is 146 nm, and grating period is 130 nm. FIG. 8 shows simulated results of reflection versus wavelength, wherein curves 15-18 correspond to #15-18 in Table IV. FIG. 8 shows that curves 15 and 16 have higher reflection, of about 6% to 17%, to short-length visible blue light. Even when the thickness d of the reflective layer 203 is as thin as 25 nm, the anti-radiation structure 200 (curve 17) still has higher reflection, to the short-length visible blue light, than substrate 201 (curve 18). In this simulated result, the reflective layer 203 with higher refractive index has higher reflection to the short-length visible blue light.

TABLE IV

| | Thickness | | | | |
|---|---|---|---|---|---|
| | d of the | Grating | Refractive | | Grating |
| | Reflective layer | height H | index | Duty cycle | period |
| #15 (TE) | 51 nm | 146 nm | 1.9 | 0.28 | 130 nm |
| #16 (TE) | 77 nm | 146 nm | 1.9 | 0.28 | 130 nm |
| #17 (TE) | 25 nm | 146 nm | 1.9 | 0.28 | 130 nm |
| #18 | 0 | 0 | 1.5 | | |

Simulated Experiment III

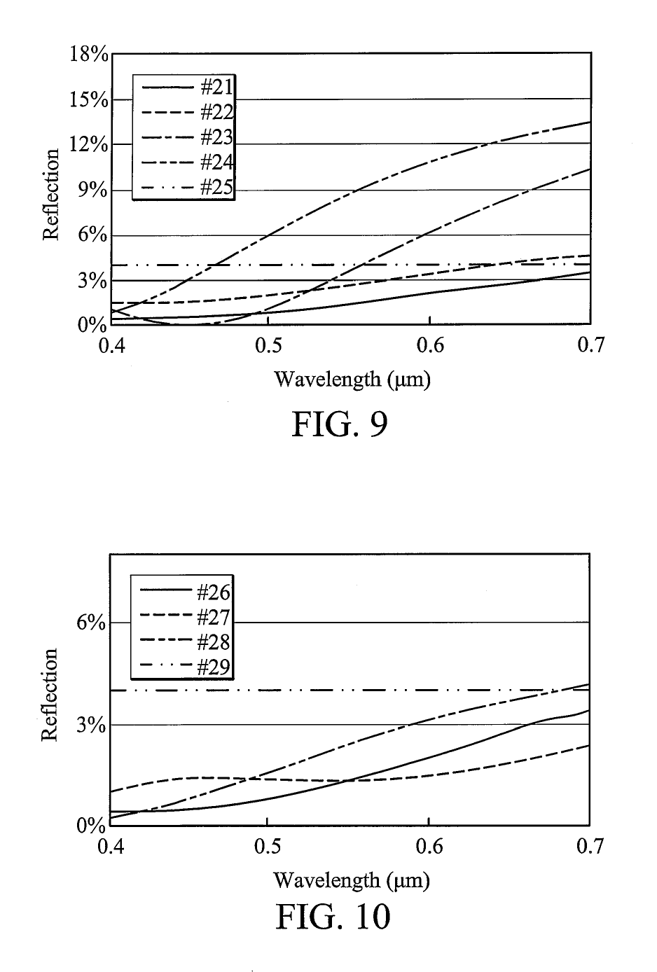

Table V shows the simulated variables of long-length visible light reflection of the anti-radiation structure 300. The refractive index of the substrate 301 is 1.5. Variables include grating height H, thickness d of the reflective layer 303, refractive index of the periodic grating 305 and the reflective layer 303 (the periodic grating 303 and the reflective layer 305 are hypothesized to be same material), duty cycle, and grating period T. #25 means that no reflective layer and periodic grating are on the substrate 301, i.e. only substrate 201 processes simulated reflection. Simulated experiment II utilizes transverse electric (TE) light and transverse magnetic (TM) light as incident light. FIG. 9 shows simulated results of reflection versus wavelength, wherein curves 21-25 correspond to #21-25 in Table V. Compared to substrate (#25), the anti-radiation structures of the invention (#21-24) have higher reflection to 550-700 nm visible light, as shown in FIG. 9. Specifically, if the reflective layer 303 and the periodic grating 305 have higher refractive index (1.9) such as #23 and #24, the anti-radiation structure has higher reflection of about 9% to 14%.

TABLE V

| | #21 (TE) | #22 (TM) | #23 (TE) | #24 (TM) | #25 |
|---|---|---|---|---|---|
| Grating height H | 70 nm | 70 nm | 60 nm | 60 nm | 0 |
| Thickness d of | 135 nm | 135 nm | 90 nm | 90 nm | 0 |
| the Reflective | | | | | |
| layer | | | | | |
| Refractive index | 1.6 | 1.6 | 1.9 | 1.9 | 1.5 |
| Duty cycle | 0.28 | 0.28 | 0.37 | 0.37 | |
| Grating period | 130 nm | 130 nm | 130 nm | 130 nm | |

Table VI shows the simulated variables of long-length visible light reflection of the anti-radiation structure 300 with different thicknesses d of the reflective layer 303. The refractive index of the periodic grating 305 and the reflective layer 303 is 1.6, the grating height H is 70 nm, and grating period is 130 nm. FIG. 10 shows simulated results of reflection versus wavelength, wherein curves 26-29 correspond to #26-29 in Table VI. FIG. 10 shows that anti-radiation structure 300 with thicker reflective layer 303 has lower reflection to long-length visible red light.

TABLE VI

| | Thickness | | | | |
|---|---|---|---|---|---|
| | d of the | Grating | Refractive | | Grating |
| | Reflective layer | height H | index | Duty cycle | period |
| #26 (TE) | 135 nm | 70 nm | 1.6 | 0.28 | 130 nm |
| #27 (TE) | 171 nm | 70 nm | 1.6 | 0.28 | 130 nm |
| #28 (TE) | 99 nm | 70 nm | 1.6 | 0.28 | 130 nm |
| #29 | 0 | 0 | 1.5 | | |

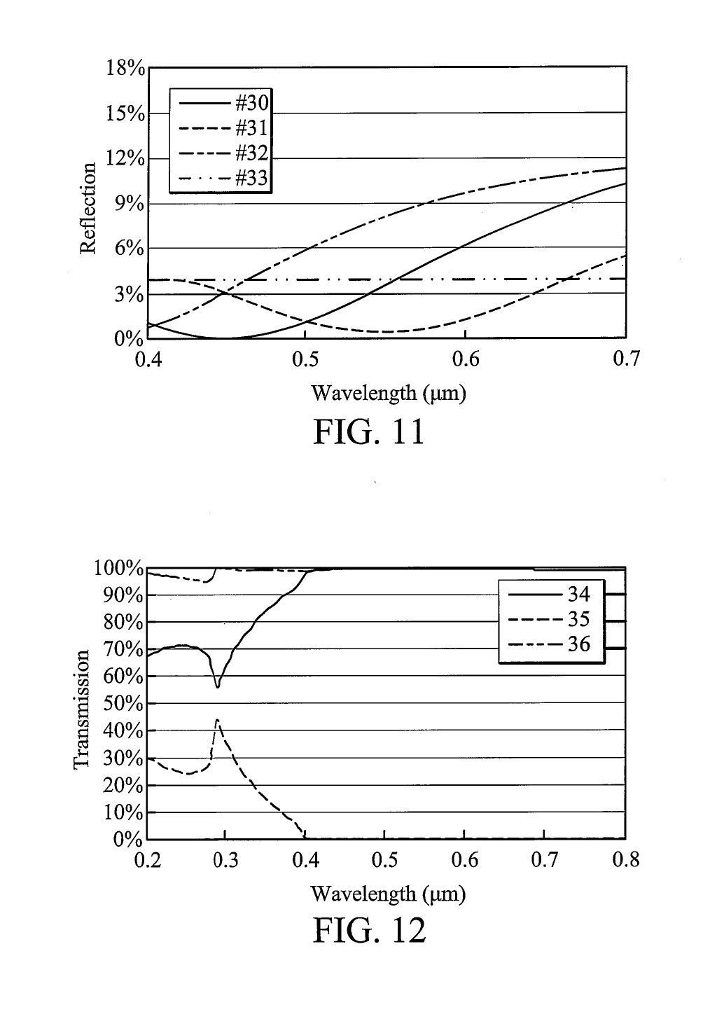

Table VII shows the simulated variables of long-length visible light reflection of the anti-radiation structure 300 with different thicknesses d of the reflective layer 303. The refractive index of the periodic grating 305 and the reflective layer 303 is 1.9, the grating height H is 60 nm, and grating period is 130 nm. FIG. 11 shows simulated results of reflection versus wavelength, wherein curves 30-33 correspond to #30-33 in Table IV. FIG. 11 shows that curves 30 and 32 have higher reflection, of about 4% to 11%, to short-length visible blue light. When the thickness d of the reflective layer 303 exceeds 100 nm, the anti-radiation structure 300 (curve 31) has lower reflection, to the short-length visible blue light, than substrate 301 (curve 33).

TABLE IV

| | Thickness | | | | |
|---|---|---|---|---|---|
| | d of the | Grating | Refractive | | Grating |
| | Reflective layer | height H | index | Duty cycle | period |
| #30 (TE) | 90 nm | 60 nm | 1.9 | 0.28 | 130 nm |
| #31 (TE) | 121 nm | 60 nm | 1.9 | 0.28 | 130 nm |
| #32 (TE) | 59 nm | 60 nm | 1.9 | 0.28 | 130 nm |
| #33 | 0 | 0 | 1.5 | | |

Simulated Experiment IV

FIG. 4 shows an anti-radiation structure 400 for transmission simulation. Variables of Simulated experiment IV include grating height H, refractive index of the substrate 401 and the periodic grating 405 (the periodic grating 405 and the substrate 401 are hypothesized to be same material), duty cycle and grating period T. The incident light of Simulated experiment IV is transverse electric (TE) light, the grating height H is 100 nm, the refractive index of the anti-radiation structure 400 is 1.4, the duty cycle is 0.5, and the grating period is 286 nm. FIG. 12 shows simulated results of transmission versus wavelength. Curve 34 means zero-order transmission, curve 35 means +/− first order transmission, and curve 36 means total transmission. As shown in FIG. 12, the anti-radiation structure 400 of the invention has lower zero-order transmission of 200-400 nm UV light. Unlike Simulated experiments I-III, the principle here is diffraction rather than reflection. By appropriately designing duty cycle, periodic grating 405 of Simulated experiment IV diffracts incident UV light, such that a part of the UV transfer to +/−first order light. As a result, the total transmission of the incident UV light is reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An anti-radiation structure, comprising:
a substrate;
a reflective layer adjacent to the substrate; and
a periodic grating adjacent to the reflective layer for reflecting an incident radiation.

2. The anti-radiation structure as claimed in claim 1, wherein the substrate comprises glass, plastic, or organic-inorganic composite.

3. The anti-radiation structure as claimed in claim 1, wherein the reflective layer has a refractive index of 1.4 to 2.0.

4. The anti-radiation structure as claimed in claim 1, wherein the periodic grating has a refractive index of 1.4 to 2.0.

5. The anti-radiation structure as claimed in claim 1, wherein the reflective layer and the periodic grating are in-mold.

6. The anti-radiation structure as claimed in claim 1, wherein the reflective layer and the periodic grating have substantially greater refractive indexes than the substrate.

7. The anti-radiation structure as claimed in claim 1, wherein the incident radiation is an ultraviolet light at 200 nm to 400 nm wavelength.

8. The anti-radiation structure as claimed in claim 7, wherein the periodic grating has a duty cycle of about 0.2 to 0.3 and a height of about 50 nm to 210 nm.

9. The anti-radiation structure as claimed in claim 7, wherein the reflective layer has a thickness of about 5 nm to 70 nm.

10. The anti-radiation structure as claimed in claim 1, wherein the incident radiation is a red light at 550 nm to 700 nm wavelength.

11. The anti-radiation structure as claimed in claim 10, wherein the periodic grating has a duty cycle of about 0.15 to 0.8 and a height of about 5 nm to 130 nm.

12. The anti-radiation structure as claimed in claim 10, wherein the reflective layer has a thickness of about 50 nm to 180 nm.

13. The anti-radiation structure as claimed in claim 1, wherein the incident radiation is a blue light at 400 nm to 550 nm wavelength.

14. The anti-radiation structure as claimed in claim 13, wherein the periodic grating has a duty cycle of about 0.15 to 0.8 and a height of about 50 nm to 210 nm.

15. The anti-radiation structure as claimed in claim 13, wherein the reflective layer has a thickness of about 10 nm to 120 nm.

16. An anti-radiation structure, comprising:
a substrate; and
a periodic grating adjacent to the substrate for diffracting an incident radiation.

17. The anti-radiation structure as claimed in claim 16, wherein the substrate comprises glass, plastic, or organic-inorganic composite.

18. The anti-radiation structure as claimed in claim 16, wherein the periodic grating comprises glass, plastic, or organic-inorganic composite.

19. The anti-radiation structure as claimed in claim 16, wherein the substrate has a refractive index of about 1.4 to 1.9, and the periodic grating has a refractive index of 1.4 to 1.9, respectively.

20. The anti-radiation structure as claimed in claim 16, wherein the refractive index of the substrate and the refractive index of the periodic grating are substantially the same.

21. The anti-radiation structure as claimed in claim 16, wherein the composition of the substrate and the composition of the periodic grating are substantially the same.

22. The anti-radiation structure as claimed in claim 16, wherein the substrate and the periodic grating are in-mold.

23. The anti-radiation structure as claimed in claim 16, wherein the incident radiation is an ultraviolet light at 200 nm to 400 nm wavelength.

24. The anti-radiation structure as claimed in claim 23, wherein the periodic grating has a duty cycle of about 0.1 to 0.9, a height of about 10 nm to 400 nm, and a grating period of about 180 nm to 340 nm.
